(19) United States
(12) Patent Application Publication
(10) Pub. No.: US 2018/0274801 A1
(43) Pub. Date: Sep. 27, 2018

(54) HIGH-RIGIDITY PLATE AND AIR-CONDITIONING APPARATUS

(71) Applicant: Kabushiki Kaisha Toshiba, Minato-ku (JP)

(72) Inventors: Misuzu Sakai, Yokohama (JP); Shanying Pan, Chigasaki (JP); Takayuki Masunaga, Yokohama (JP); Kaori Deura, Yokohama (JP); Toshihiko Kida, Yokohama (JP); Kosuke Adachi, Yokohama (JP); Makoto Ootaki, Kawasaki (JP)

(73) Assignee: Kabushiki Kaisha Toshiba, Minato-ku (JP)

(21) Appl. No.: 15/908,919

(22) Filed: Mar. 1, 2018

(30) Foreign Application Priority Data
Mar. 24, 2017 (JP) 2017-059453

(51) Int. Cl. F24F 1/56; F16M 5/00

(52) U.S. Cl. CPC F24F 1/56; F16M 5/00

(57) ABSTRACT

According to an embodiment, a high-rigidity plate includes: a first protrusion including a first top wall configured to support a vibration member and a first circumferential wall connected with an outer circumferential edge of the first top wall, the first protrusion being configured to protrude inside a housing or outside the housing; an intermediate part disposed at a position surrounding the first top wail when viewed along a first direction and connected with the first circumferential wall via a first bend; and an annular second protrusion including a second top wall disposed at a position surrounding the first top wall when viewed along the first direction and a second circumferential wall connected with the intermediate part via a second bend and connected with an inner circumferential edge of the second top wall, the second protrusion being configured to protrude inside the housing or outside the housing.

### CROSS-REFERENCE TO RELATED APPLICATIONS

This application is based upon and claims the benefit of priority from Japanese Patent Application No. 2017-059453, filed on Mar. 24, 2017, the entire contents of which are incorporated herein by reference.

### FIELD

Embodiments described herein relate generally to a high-rigidity plate and an air-conditioning apparatus.

### BACKGROUND

A known air-conditioning apparatus houses a motor and other components inside a housing.

In an air-conditioning apparatus of this type, when a wall of a housing that supports a vibration member composed of a turbofan as a vibration source and a motor as a vibration transmission member, has low rigidity, the air-conditioning apparatus may have large vibrations of the wall arising from vibrations of the turbofan. It is preferable that a high-rigidity plate for supporting a vibration member, offering increased rigidity, and an air-conditioning apparatus including the high-rigidity plate can be obtained.

### BRIEF DESCRIPTION OF THE DRAWINGS

FIG. 1 is an exemplary and schematic perspective view of an air-conditioning apparatus according to an embodiment;

FIG. 2 is an exemplary and schematic sectional view of the air-conditioning apparatus in the embodiment;

FIG. 3 is an exemplary and schematic perspective view of a ceiling wall of the air-conditioning apparatus in the embodiment;

FIG. 4 is an exemplary and schematic bottom view of the ceiling wall of the air-conditioning apparatus in the embodiment;

FIG. 5 is a sectional view taken along a line V-V in FIG. 4; and

FIG. 6 is a sectional view taken along a line VI-VI in FIG. 4.

### DETAILED DESCRIPTION

According to an embodiment, a high-rigidity plate includes a first protrusion, an intermediate part and an second protrusion. The first protrusion includes a first top wall and a first circumferential wall. The first top wall is configured to support a vibration member. The first circumferential wall is connected with an outer circumferential edge of the first top wall. The first protrusion is configured to protrude inside a housing or outside the housing. The intermediate part is disposed at a position surrounding the first top wall when viewed along a first direction and connected with the first circumferential wall via a first bend. The second protrusion is annular in shape and includes a second top wall and a second circumferential wall. The second top wall is disposed at a position surrounding the first top wall when viewed along the first direction. The second circumferential wall is connected with the intermediate part via a second bend and connected with an inner circumferential edge of the second top wall. The second protrusion is configured to protrude inside the housing or outside the housing.

The following discloses an exemplary embodiment of the present invention. The configuration of the embodiment described below and operation and effects achieved by the configuration are illustrative only. The invention is embodied with configurations other than the configuration disclosed herein. Additionally, the present invention can achieve at least one of various effects (including secondary effects) achieved by the configuration.

In each drawing, directions are defined for convenience. The X-direction, the Y-direction, and the Z-direction are intersecting each other. In this specification, ordinal numbers are used to distinguish one part or member from another and do not denote an order or preference.

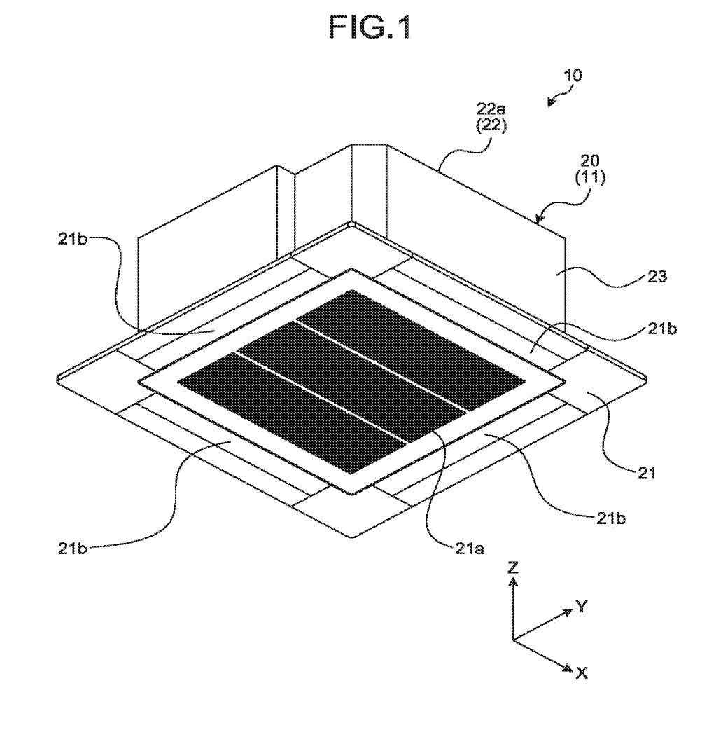

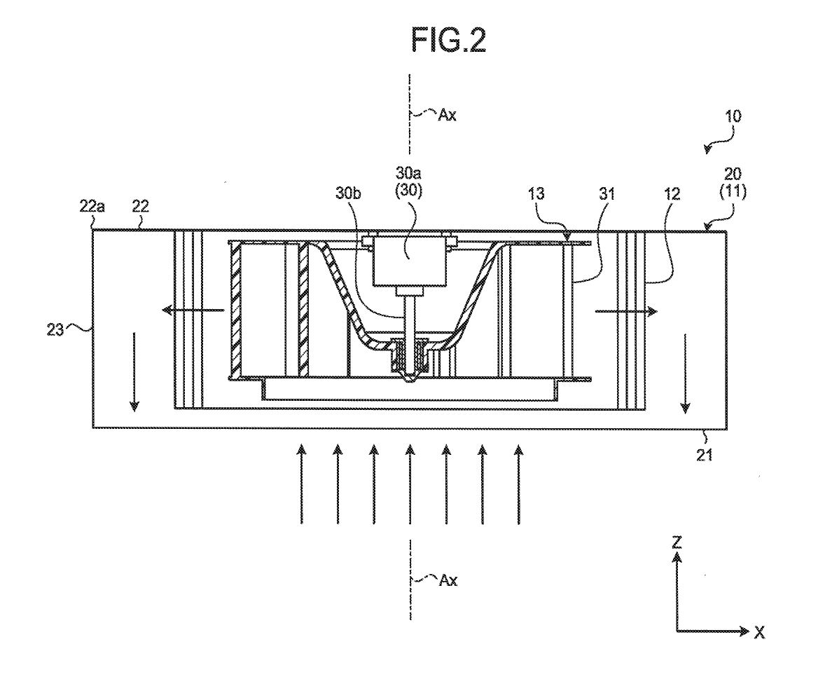

FIG. 1 is an exemplary and schematic perspective view of an air-conditioning apparatus 10 in the embodiment. FIG. 2 is an exemplary and schematic sectional view of the air-conditioning apparatus 10 in the embodiment.

The air-conditioning apparatus 10 illustrated in FIGS. 1 and 2 is configured as, what is called, a cassette type indoor unit disposed at a ceiling (not illustrated) of a building. The air-conditioning apparatus 10 and an outdoor unit (not illustrated) disposed outside the building constitute an air-conditioning system that performs cooling and heating.

The air-conditioning apparatus 10 includes a housing 11, a heat exchanger 12 (FIG. 2), and a blower 13 (FIG. 2). The heat exchanger 12 and the blower 13 are housed inside the housing 11. The term “vertical direction”, as used in the following description, refers to a vertical direction (the Z-direction and the direction opposite to the Z-direction) of the housing 11 (air-conditioning apparatus 10).

The housing 11 is formed into a substantially rectangular shape. The housing 11 includes a base 20 and a decorative panel 21. The base 20 includes a ceiling wall 22 and a tubular portion 3. The base 20 is formed of, for example, a metal material, such as iron and stainless steel. It is noted that FIG. 2 schematically illustrates the housing 11.

The ceiling wall 22 extends along an X-Y plane. Specifically, the ceiling wall 22 extends in a direction intersecting the Z-direction (first direction). The ceiling wall 22 is manufactured through stamping of a single sheet of plate stock. The ceiling wall 22 will be detailed later. The ceiling wall 22 is referred to also as a plate or a top plate. The ceiling wall 22 is an exemplary high-rigidity plate. The Z-direction is an exemplary first direction.

The tubular portion 23 extends inferiorly (in the direction opposite to the -direction) from an outer edge 22a of the ceiling wall 22. The tubular portion 23 is fixed to a frame of the building. The fixing of the tubular portion 23 results in the housing 11 being fixed to the frame of the building. The tubular portion 23 is referred to also as a plate portion or a circumferential portion.

The decorative panel 21 is fixed to the tubular portion 23 under a condition in which the decorative panel 21 covers an opening in a lower end portion of the tubular portion 23. The decorative panel 21 has an inlet port 21a (FIG. 1) and outlet ports 21b (FIG. 1). The inlet port 21a is disposed at a central portion of the decorative panel 21. The inlet port 21a has a plurality of slits and generally has a rectangular shape. The plurality of outlet ports 21b, each having an elongated rectangular shape, are disposed around the inlet port 21a so as to surround the inlet port 21a. The inlet port 21a and the outlet ports 21b pass through the decorative panel 21, making the inside and the outside of the housing 11 communicate with each other. Specifically, the housing 11 is configured to allow air to flow in and out of the housing 11 through the inlet port 21a and the outlet ports 21b. The decorative panel 21 is referred to also as a bottom wall or a bottom plate.

Reference is made to FIG. 2. The heat exchanger 12 is formed into a rectangular tubular shape extending in the vertical direction to thereby surround the blower 13. The heat exchanger 12 is connected with, for example, a compressor or an outdoor heat exchanger disposed in the outdoor unit via a refrigerant pipe. The heat exchanger 12 and the compressor or the outdoor heat exchanger constitute a refrigeration cycle. In the heat exchanger 12, heat exchange is performed between indoor air sent by the blower 13 and a refrigerant flowing through the heat exchanger 12.

As illustrated in FIG. 2, the blower 13 includes a motor 30 and a fan 31. The motor 30 includes a case 30a and a rotary shaft 30b. The case 30a is fixed to the ceiling wall 22. The rotary shaft 30b is supported by the case 30a rotatably about a central axis Ax and extends inferiorly from the case 30a. The central axis Ax extends in the vertical direction. The rotary shaft 30b rotates when the motor 30 is energized. The motor 30 is an exemplary vibration transmission member that transmits vibration generated by the fan 31.

The fan 31 is fixed to the rotary shaft 30b of the motor 30 and rotates integrally with the rotary shaft 30b about the central axis Ax. The fan 31 is an exemplary vibration source that generates vibration. The motor 30 as the vibration transmission member and the fan 31 as the vibration source that generates vibration are collectively referred to as a vibration member. The fan 31 is configured as a turbofan that draws in air axially along the central axis Ax and blows the air radially with respect to the central axis Ax. The heat exchanger 12 is disposed outside in the radial direction with respect to the central axis Ax of the fan 31, so that the fan 31 is surrounded by the heat exchanger 12. The fan 31, when driven by the motor 30, blows air drawn inside the housing 11 from the inlet port 21a, outside the housing 11 via the heat exchanger 12.

Through the foregoing configuration, room air is drawn inside the housing 11 by the blower via the inlet port 21a during a refrigeration cycle operation. The air drawn in the housing 11 passes through the heat exchanger 12. Heat exchange is performed between the refrigerant in the heat exchanger 12 and the air passing through the heat exchanger 12. For a cooling operation, the air is cooled and blown out from the outlet ports 21b. For a heating operation, the air is heated and blown out from the outlet ports 21b.

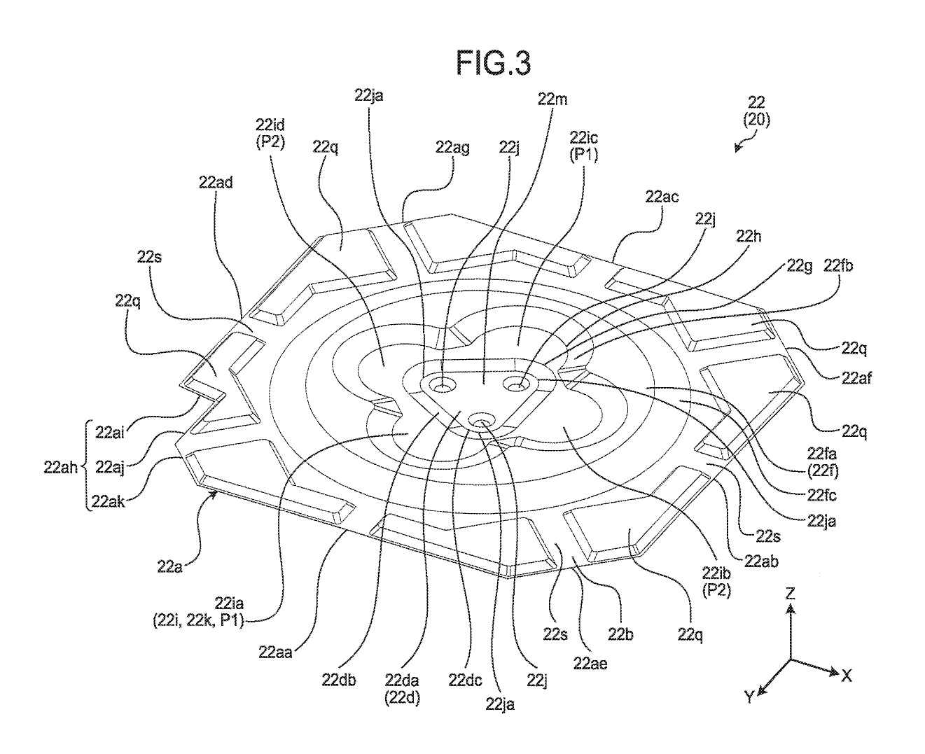

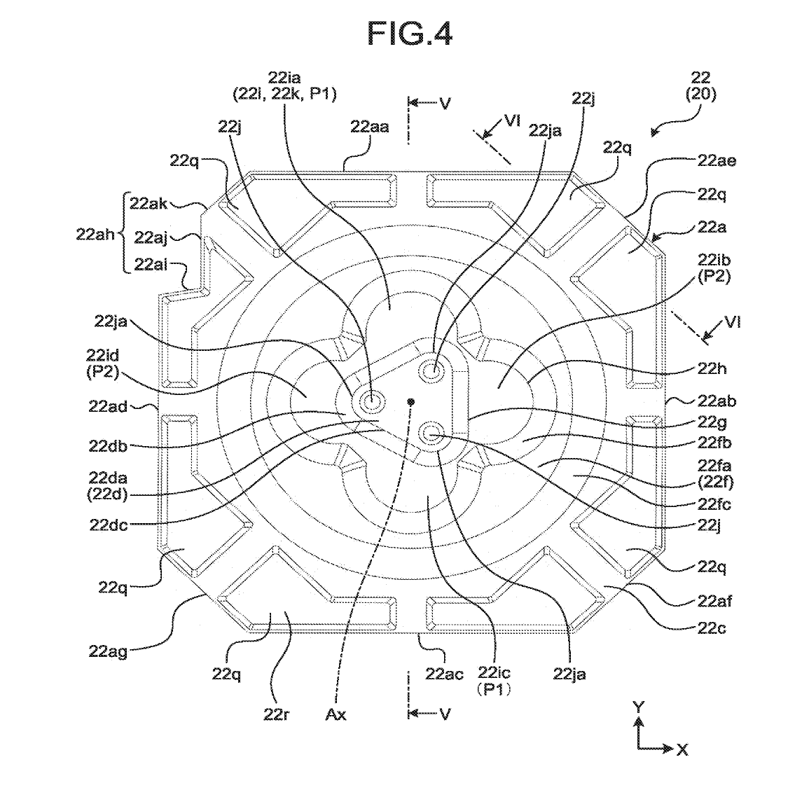

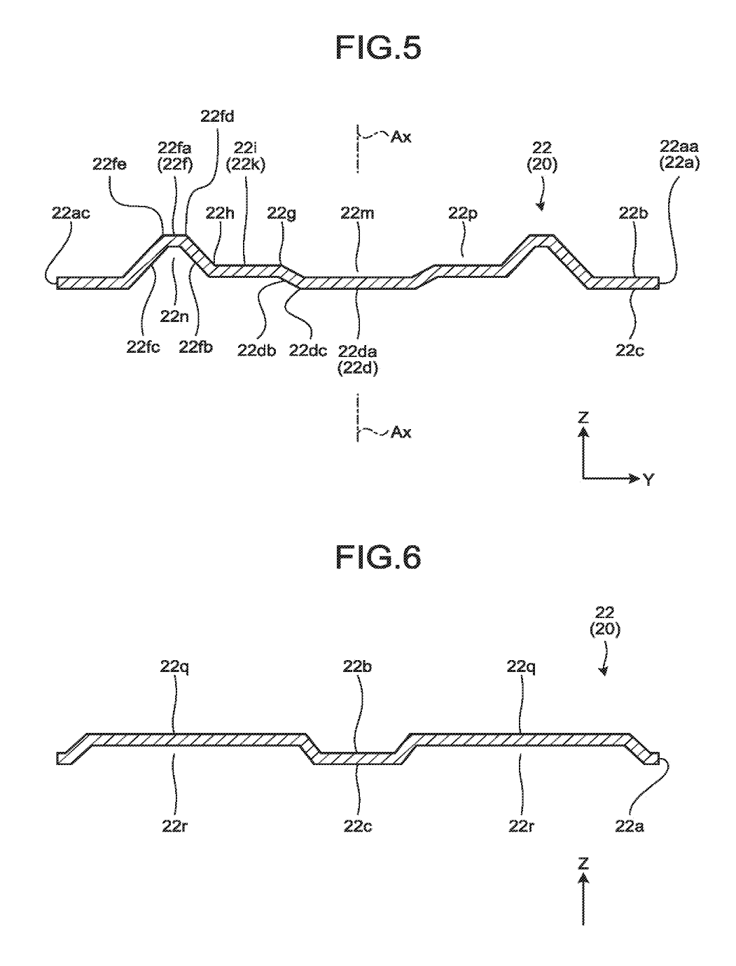

The following details the ceiling wall 22. FIG. 3 is an exemplary and schematic perspective view of the ceiling wall 22 of the air-conditioning apparatus 10 in the embodiment. FIG. 4 is an exemplary and schematic bottom view of the ceiling wall 22 of the air-conditioning apparatus 10 in the embodiment. FIG. 5 is a sectional view taken along the line V-V in FIG. 4. FIG. 6 is a sectional view taken along the line VI-VI in FIG. 4.

As illustrated in FIGS. 3 and 4, the ceiling wall has an outer surface 22b and an inner surface 22c. The outer edge 22a of the ceiling wall 22 has four sides 22aa to 22ad and four connections 22ae to 22ah. The outer surface 22b is referred to also as an upper surface. The inner surface 22c is referred to also as a lower surface.

The sides 22aa and 22ac extend linearly along the X-direction. The sides 22aa and 22ac are spaced apart from each other in the Y-direction such that the base 20 has a central portion disposed between the sides 22aa and 22ac. The sides 22aa and 22ac extend substantially in parallel with each other.

The sides 22ab and 22ad extend linearly along the Y-direction. The sides 22ab and 22ad are spaced apart from each other in the X-direction such that the base 20 has the central portion disposed between the sides 22ab and 22ad. The sides 22ab and 22ad extend substantially in parallel with each other.

The four connections 22ae to 22ah connect the respective four sides 22aa to 22ad together. The connection 22ae extends linearly between an end of the side 22aa in the X-direction and an end of the side 22ab in the Y-direction. The connection 22ae is inclined with respect to the X-direction and the Y-direction.

The connection 22af extends linearly between an end of the side 22ab in the direction opposite to the Y-direction and an end of the side 22ac in the X-direction. The connection 22af is inclined with respect to the X-direction and the Y-direction.

The connection 22ag extends linearly between an end of the side 22ac in the direction opposite to the X-direction and an end of the side 22ad in the direction opposite to the Y-direction. The connection 22ag is inclined with respect to the X-direction and the Y-direction.

The connection 22ah extends in a stepwise manner between an end of the side 22ad in the Y-direction and an end of the side 22aa in the direction opposite to the X-direction. The connection 22ah includes three straight-line sections 22ai to 22ak. The straight-line section 22ai extends linearly from an end of the side 22ad in the Y-direction and is inclined with respect to the X-direction and the Y-direction. The straight-line section 22aj extends linearly in the Y-direction from an end of the straight-line section 22ai in the X-direction. The straight-line section 22ak is disposed linearly between an end of the straight-line section 22aj in the Y-direction and an end of the side 22aa in the direction opposite to the X-direction. The straight-line section 22ak is inclined with respect to the X-direction and the Y-direction. It is noted that the connection 22ah extends in a stepwise manner in the embodiment but is not limited to this shape. The connection 22ah may have any shape as long as the connection 22ah connects the end of the side 22ad in the Y-direction and the end of the side 22aa in the direction opposite to the K-direction.

Reference is made to FIGS. 3 to 5. The ceiling wall include a first protrusion 22d, a second protrusion 22f, a first bend 22g, a second bend 22h, and an intermediate part 22i. The first protrusion 22d is disposed at a central portion of the ceiling wall 22. The second protrusion 22f is disposed around the first protrusion 22d. The first bend 22g, the second bend 22h, and the intermediate part 22i are disposed between the first protrusion 22d and the second protrusion 22f. The first bend 22g, the second bend 22h, and the intermediate part 22i constitute an intermediate portion 22k that is disposed between the first protrusion 22d and the second protrusion 22f. The first protrusion 22d is referred to also as an inside protrusion or bead and the second protrusion 22f is referred to also as an outside protrusion or bead.

The first protrusion 22d protrudes inside the housing 11. More specifically, the first protrusion 22d protrudes inside the housing 11 from the intermediary portion 22k. The outer surface 22b in the first protrusion 22d has a recess 22m (opening). The first protrusion 22d has a first top wall 22da and a first circumferential wall 22db . The first top wall 22da extends along the X-Y plane.

The first circumferential wall 22db is formed annularly around the first top wall 22da and connected with an outer circumferential edge 2dc of the first top wall 22da . The first top wall 22da supports the motor 30. The first top wall 22da supports the fan 31 via the motor 30. In other words, the first top wall 22da supports the vibration member. In detail, the first top wall 22da includes a plurality of (exemplarily, three) supports 22j disposed around the central axis Ax of the motor 30 when viewed along the Z-direction. The supports 22j protrude in the direction opposite to the Z-direction. A stud bolt or any other fastener is fixed to each of the supports 22j and the case 30a of the motor 30 is fixed to the supports 22j via the fasteners. That is, the supports 22j support the motor 30. The supports 22j support the fan 31 via the motor 30. In other words, the supports 22j support the vibration member. The first top wall 22da is formed into a polygonal shape (exemplarily, a triangle) having corners 22ja provided for the respective supports when viewed along the Z-direction. It is noted that the corners 22ja may be curved or right-angled.

The second protrusion 22f is formed annularly and protrudes outside the housing 11. In detail, the second protrusion 22f protrudes outside the housing 11 from the intermediate portion 22k. The inner surface 22c in the second protrusion 22f has a recess 22n (opening). The second protrusion 22f is disposed at a position surrounding the first top wall 22da when viewed along the Z-direction (FIG. 4). In addition, the second protrusion 22f is connected with the first protrusion 22d via the first bend 22g including an end of the first circumferential wall 22db remote from the first top wall 22da and the second bend 22h including an end of the intermediates part 22i remote from the first bend 22g. The second protrusion 22f has a second top wall 22fa, a second circumferential wall 22fb, and a third circumferential wall 22fc. The second top wall 22fa extends along the X-Y plane. The second top wall 22fa is disposed at a position surrounding the first top wall 22da when viewed along the Z-direction. The second circumferential wall 22fb is formed annularly in the inner circumferential direction of the second top wall 22fa and connected with an inner circumferential edge 22fd (FIG. 5) of the second top wall 22fa and the second bend 22h. The third circumferential wall 22fc is formed annularly in the outer circumferential direction of the second top wail 22fa and connected with an outer circumferential edge 22fe (FIG. of the second top wall 22fa. The second circumferential wall 22fb is referred to also as an inner circumferential wall and the third circumferential wall 22fc is referred to also as an outer circumferential wall.

The first bend 22g is formed annularly around the first protrusion 22d and connected with the first circumferential wall 22db of the first protrusion 22d. The second bend 22h is formed annularly around the first bend 22g and connected with the second protrusion 22f.

The intermediate part 22i is disposed between the first bend 22g and the second bend 22h. The intermediate part 22i is formed annularly along the X-Y plane. When viewed along the Z-direction, the intermediate part 22i is disposed at a position surrounding the first top wall 22da of the first protrusion 22d and connected with the first top wall 22da via the first bend 22g. The outer surface 22b in the intermediate part 22i has a recess 22p (opening, FIG. 5) surrounded by the first protrusion 22d and the second protrusion 22f. The recess 22p is connected with the recess 22m. In other words, a larger opening is formed in the recess 22p than in the recess 22m. In other words again, the recess 22p is formed such that the opening is enlarged from the first top wall 22da of the first protrusion 22d toward the Z-direction by way of the intermediate portion 22k.

The intermediate part 22i includes a plurality of third protrusions 22ia to 22id that protrude in a direction (e.g., X-direction and Y-direction) intersecting the Z-direction. The third protrusion 22ia and the third protrusion 22ic protrude in directions opposite to each other. In detail, the third protrusion 22ia protrudes in the Y-direction and the third protrusion 22ic protrudes in the direction opposite to the Y-direction. The third protrusion 22ia and the third protrusion 22ic constitute one set P1. Similarly, the third protrusion 22ib and the third protrusion 22id protrude in directions opposite to each other. In detail, the third protrusion 221b protrudes in the X-direction and the third protrusion 22id protrudes in the direction opposite to the X-direction. The third protrusion 22ib and the third protrusion 22id constitute one set P2.

As described above, the embodiment includes one or more (exemplarily, two) sets being the sets P1 and P2, each including two of the third protrusions 22ia to 22id protruding in directions opposite to each other. The third protrusions 22ia and 22ic constituting the set P1 protrude in the Y-direction and the direction opposite to the Y-direction and the protrusions 221ib and 22id constituting the set P2 protrude in the X-direction and the direction opposite to the X-direction. That is, directions in which third protrusions of one of the two sets P1 and P2 among the third protrusions 22ia to 22id protrude, intersect directions in which third protrusions of the other of the two sets P1 and P2 among the third protrusions 22ia to 22id protrude.

Reference is made to FIGS. 3, 4, and 6. The ceiling wall 22 includes a plurality of fourth protrusions 22q. The fourth protrusions 22q protrude outside the housing 11. In detail, the fourth protrusions 22q protrude outside the housing 11 from the outer surface 22b surrounding the fourth protrusions 22q. The fourth protrusions 22q have a height equal to or lower than a height of the second protrusion 22f. It is noted that the height of the fourth protrusions 22q is not limited to the foregoing and may be higher than the height of the second protrusion 22f. That is, the height of the fourth protrusions 22q may be any height. The inner surface 22c in the fourth protrusions 22q has a recess 22r (opening). When viewed along the Z-direction (first direction), the fourth protrusions 22q are disposed at a position surrounding the second protrusion 22f (FIG. 4). Additionally, the fourth protrusions 22q are spaced apart from each other. The foregoing arrangement results in the outer surface 22b of the ceiling wall 22 having a plurality of grooves 22s (FIG. 3) formed between each pair of the fourth protrusions 22q. The grooves 22s are formed radially around the central portion of the ceiling wall 22. The grooves 22s each have a circumferential width around the central portion (central axis Ax) of the ceiling wall 22 smaller than a circumferential width of each of the fourth protrusions 22q around the central portion (central axis Ax) of the ceiling wall 22. It is noted that the grooves 22s each may have the circumferential width about the central portion (central axis Ax) of the ceiling wall 22 greater than the circumferential width of each of the fourth protrusions 22q about the central portion (central axis Ax) of the ceiling wall 22. The fourth protrusions 22q are referred to also as beads.

As described above, exemplarily in the embodiment, the ceiling wall 22 (high-rigidity plate) of the housing 11 includes the first protrusion 22d, the intermediate part 22i, and the second protrusion 22f. The first protrusion 22d has the first top wall 22da that supports the motor 30 (vibration transmission member) in which the fan 31 (vibration source) generating vibration is mounted and the first circumferential wall 22db connected with the outer circumferential edge 22dc of the first top wall 22da . The first protrusion 22d protrudes inside the housing 11. When viewed along the Z-direction (first direction), the intermediate part 22i is disposed at the position surrounding the first top wall 22da and connected with the first circumferential wall 22db via the first bend 22g. The second protrusion 22f is formed annularly. When viewed along the Z-direction (first direction), the second protrusion 22f includes the second top wall 22fa disposed at the position surrounding the first top wall 22da and the second circumferential wall 22fb connected with the intermediate part 22i via the second bend 22h and with the inner circumferential edge 22fd of the second top wall 22fa. Thus, in accordance with the embodiment, the ceiling wall 22 has a high rigidity compared, for example, with a configuration having only one protrusion. Thus, vibration (downward vibration) of the ceiling wall 22 caused by vibration (operation) of the fan 31 can be minimized. Further, it is thereby easy to, for example, increase a speed of a peak of resonance of the ceiling wall 22, so that it is easy to bring the peak to fall outside an operating speed range of the motor 30 in operation.

In the embodiment, exemplarily, the ceiling wall 22 includes the first bend 22g connected with the first protrusion 22d, the second bend 22h connected with the second protrusion 22f, and the intermediate part 22i disposed between the first bend 22g and the second bend 22h. Thus, in accordance with the embodiment, exemplarily, the two bends (the first bend 22g and the second bend 22h) increase rigidity of the ceiling wall 22.

In the embodiment, exemplarily, the intermediate part 22i includes the third protrusions 22ia to 22id that protrude in the direction intersecting the Z-direction. Thus, in accordance with the embodiment, exemplarily, the third protrusions 22ia to 22id increase rigidity of the ceiling wall 22.

In the embodiment, exemplarily, the intermediate part 22i includes one or more sets being the sets P1 and P2, each including two of the third protrusions 22ia to 22id protruding in directions opposite to each other. Thus, in accordance with the embodiment, exemplarily, one or more sets being the sets P1 and P2, each including two of the third protrusions 22ia to 22id, increase rigidity of the ceiling wall 22.

In the embodiment, exemplarily, the two sets P1 and P2, each including two of the third protrusions 22ia to 22id protruding in directions intersecting each other, are provided. Thus, in accordance with the embodiment, exemplarily, regarding the two sets P1 and P2, directions in which third protrusions of one of the two sets among the third protrusions 22ia to 22id protrude, intersect directions in which third protrusions of the other of the two sets among the third protrusions 22ia to 22id protrude, so that rigidity of the ceiling wall 22 is increased.

In the embodiment, exemplarily, the first top wall includes the supports 22j that are disposed around the central axis Ax of the motor 30 when viewed along the Z-direction to thereby support the fan 31. The first top wall 22da is formed into a polygonal shape having the corners 22ja provided for the respective supports 22j when viewed along the Z-direction. Thus, in accordance with the embodiment, exemplarily, the polygonal first top wall 22da increases rigidity of the wall.

It is noted that, although the embodiment has been described for an exemplary arrangement in which the first protrusion 22d protrudes inside the housing 11, the first protrusion 22d may protrude outside the housing 11. Additionally, although the embodiment has been described for an exemplary arrangement in which the second protrusion 22f protrudes outside the housing 11, the second protrusion 22f may protrude inside the housing 11. Additionally, although the embodiment has been described for an exemplary arrangement in which the fourth protrusions 22q protrude outside the housing 11, the fourth protrusions 22q may protrude inside the housing 11. Additionally, although the embodiment has been described for an exemplary arrangement in which the fourth protrusions 22q are disposed to be spaced away from each other, a single fourth protrusion 22g may be disposed annularly to surround the second protrusion 22f.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A high-rigidity plate comprising:
a first protrusion including a first top wall configured to support a vibration member and a first circumferential wall connected with an outer circumferential edge of the first top wall, the first protrusion being configured to protrude inside a housing or outside the housing;
an intermediate part disposed at a position surrounding the first top wall when viewed along a first direction and connected with the first circumferential wall via a first bend; and
an annular second protrusion including a second top wall disposed at a position surrounding the first top wall when viewed along the first direction and a second circumferential wall connected with the intermediate part via a second bend and connected with an inner circumferential edge of the second top wall, the second protrusion being configured to protrude inside the housing or outside the housing.

2. The plate according to claim 1, wherein the intermediate part is annular in shape.

3. The plate according to claim 1, wherein the first circumferential wall is annular in shape.

4. The plate according to claim 1, wherein the second circumferential wall is annular in shape.

5. The plate according to claim 1, wherein the intermediate part includes a plurality of third protrusions protruding in a direction intersecting the first direction.

6. The plate according to claim 5, wherein the plurality of third protrusions form one or more sets, each including two third protrusions protruding in directions opposite to each other.

7. The plate according to claim 6, wherein the one or more sets include two sets, and directions in which third protrusions of one of the two sets protrude, intersect directions in which third protrusions of the other of the two sets protrude.

8. The plate according to claim 1, wherein
the first protrusion includes:
a plurality of supports for supporting the vibration member; and
the first top wall that has corners provided for the respective supports and that is formed into a polygonal shape when viewed along the first direction.

9. An air-conditioning apparatus comprising:
a housing;
the high-rigidity plate according to claim 1, disposed in the housing;
a heat exchanger housed inside the housing;
a motor housed inside the housing; and
a fan housed inside the housing, the fan being driven by the motor to blow air outside the housing via the heat exchanger.
